(19) United States
(12) Patent Application Publication
(10) Pub. No.: US 2021/0199058 A1
(43) Pub. Date: Jul. 1, 2021

(54) VALVE FOR CONTROLLING EXHAUST GAS OR FRESH AIR IN A DRIVE UNIT OF A MOTOR VEHICLE OR OF A GENERATOR

(71) Applicant: Vitesco Technologies GmbH, Hannover (DE)

(72) Inventors: Robert GROTKOWSKI, Schwalbach a. Ts. (DE); Rolf ANSCHICKS, Schwalbach a. Ts. (DE); Peter WELTEROTH, Schwalbach a. Ts. (DE)

(21) Appl. No.: 17/269,619

(22) PCT Filed: Aug. 20, 2019
(86) PCT No.: PCT/EP2019/072264

§ 371 Date: Feb. 19, 2021

(30) Foreign Application Priority Data
Aug. 21, 2018 (DE) 10 2018 214 069.3

(51) Int. Cl. F02D 9/10; F02M 26/70; F16K 1/22; F16K 27/02; F16K 31/04

(52) U.S. Cl. CPC F02D 9/1035; F02M 26/70; F16K 31/041; F16K 27/0218; F16K 1/221

(57) ABSTRACT

A valve of a drive unit of a motor vehicle, having a valve housing that is thermally decoupled from a motor housing. Components of an electric-motor drive and of a transmission that are arranged in the motor housing are thus protected against thermal loads. The valve can be manufactured inexpensively and has a particularly small installation space.

### CROSS REFERENCE TO RELATED APPLICATIONS

This is a U.S. national stage of Application No. PCT/EP2019/072264 filed Aug. 20, 2019. Priority is claimed on German Application No. DE 10 2018 214 069.3 filed Aug. 21, 2018 the content of which is incorporated herein by reference.

### BACKGROUND OF THE INVENTION

### 1. Field of the Invention

The invention relates to a valve for controlling exhaust gas or fresh air in a drive unit of a motor vehicle or generator, having a valve housing that has a duct, an adjustable valve body for opening or closing a flow cross section of the duct, and an electric-motor drive for adjusting the valve body.

### 2. Description of Related Art

Such valves are commonly used in internal combustion engines or fuel cells of motor vehicles or generators and are known from practice. In such systems, the duct often carries hot exhaust gas or is connected to components that are subject to high thermal loads. This high thermal load is conducted to the electric-motor drive. Since the electric-motor drive and components of a transmission, which are connected to the electric-motor drive can be thermally overloaded, a water-type cooling arrangement is used in the valve known from practice. However, such a water-type cooling arrangement is very expensive and requires a large installation space.

### SUMMARY OF THE INVENTION

One aspect of the invention is based on developing a valve of the type mentioned in the introduction such that said valve can be produced particularly inexpensively and has a particularly small installation space.

According to one aspect of the invention in that the duct is thermally decoupled from the electric-motor drive.

By this design, the thermal load on the electric-motor drive is kept particularly low. The thermal decoupling allows the manufacture of independent assemblies of the electric-motor drive and of the valve housing. Due to one aspect of the invention, a complex and large-volume water-type cooling arrangement can be avoided. The valve according to one aspect of the invention can therefore be produced particularly inexpensively and has a particularly small installation space.

According to another advantageous refinement of the invention, a contribution to further protection against thermal loads is made if the electric-motor drive forms a structural unit together with a transmission. In this way, not only the electric-motor drive but also the transmission for driving the valve body is protected from thermal loads from the duct.

According to another advantageous refinement of the invention, the thermal decoupling is structurally particularly simple if the electric-motor drive is arranged in a motor housing and if an insulator is arranged between the motor housing and the valve housing. In the simplest case, the insulator is an air gap. In this way, the valve housing and the motor housing can be manufactured from metal and ensure high stability of the valve.

According to another advantageous refinement of the invention, the valve can be installed particularly easily if the motor housing and the valve housing each have mutually opposite flanges and if the insulator spaces the flanges apart from one another. Furthermore, once the valve housing and the motor housing have been selected, the valve can be easily assembled in a modular system.

According to another advantageous refinement of the invention, high stability of the valve with a very high degree of thermal decoupling can be achieved if the insulator is manufactured from plastic. The thickness of the insulation can be easily set by the height of the plastic. The plastic preferably has a height of at least 3 mm.

According to another advantageous refinement of the invention, the insulator is of particularly simple construction if the insulator has at least one ring element for spacing the duct apart from the electric-motor drive. A ring element has the advantage that the cross section of the possible heat conduction is particularly small.

According to another advantageous refinement of the invention, the insulating effect of the insulator can be easily adjusted if the wall thickness of the ring element is smaller than the height of the ring element.

According to another advantageous refinement of the invention, the valve has high stability with a small contact area between motor housing and valve housing if the motor housing and the valve housing are connected to one another via a transverse support arranged at a distance from the flange and if the transverse support has an insulator.

According to another advantageous refinement of the invention, a contribution to further thermal decoupling is made if a drive shaft fastened to the valve body and protruding into the motor housing is manufactured from a thermally poorly conductive material, in particular plastic.

### BRIEF DESCRIPTION OF THE DRAWINGS

The invention permits numerous embodiments. To further illustrate its basic principle, one of these embodiments is illustrated in the drawing and will be described in the following text. In the drawings:

FIG. 1 is a subregion of a motor vehicle having a drive machine and a valve; and

FIG. 2 is an enlarged perspective exploded illustration of the valve from FIG. 1.

### DETAILED DESCRIPTION OF THE PRESENTLY PREFERRED EMBODIMENTS

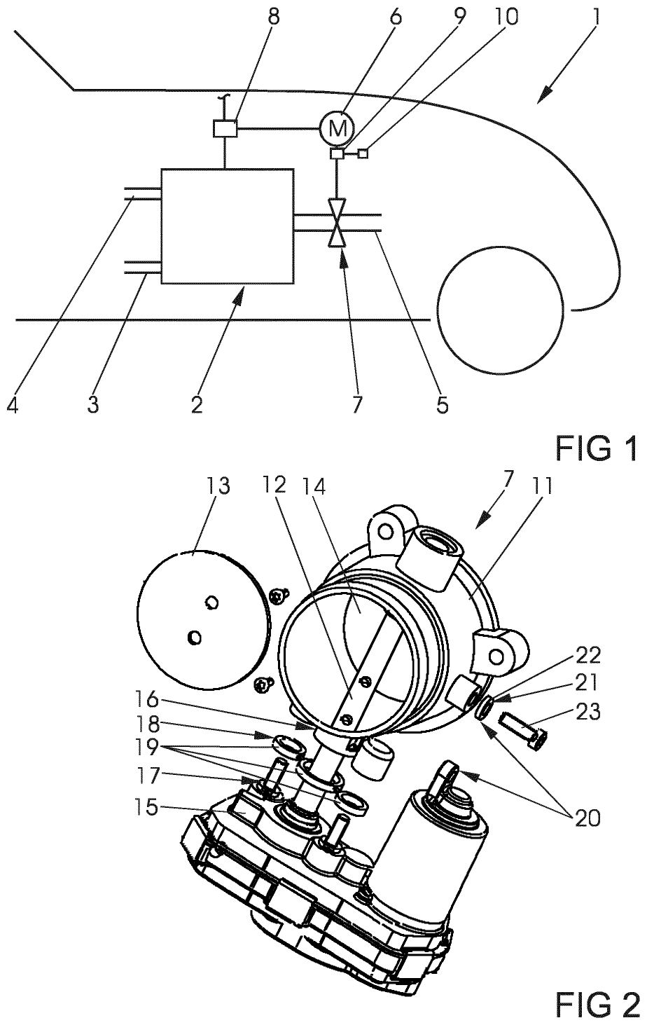

FIG. 1 is a subregion of a motor vehicle 1 having a drive unit that has a drive machine 2. The drive unit has two feed ducts 3, 4 for fuel, for example gaseous fuel, and for fresh air, and an exhaust gas tract 5. The drive machine 2 may be, for example, a fuel cell or an internal combustion engine. Arranged in the exhaust gas tract 5 is a valve 7 that is controllable by an electric-motor drive 6.

In an embodiment that is not illustrated, the valve 7 may also be arranged in the feed duct 3, 4 that conducts fresh air or conducts fuel.

Electric current generated by the drive machine 2 is supplied to a control device 8. The control device 8 is connected to an on-board electrical system (not illustrated) of the motor vehicle. The electric-motor drive 6 of the valve 7 is supplied with electric current via the control device 8. Arranged between the valve 7 and the electric-motor drive 6 is a transmission 9 having a position sensor 10. The position sensor 10 detects the position and thus the function of the valve 7.

FIG. 2 shows an enlarged exploded illustration of the valve 7 with the electric-motor drive 6 from FIG. 1. The valve 7 has a valve housing 11, which is to be mounted in the exhaust gas tract 5 from FIG. 1 and which has a valve body 13 arranged in the valve housing and which can be screwed onto a drive shaft 12. The valve body 13 can be adjusted, and thus open or close a duct 14 of the exhaust gas tract 5, by the drive shaft 12 being driven.

The electric-motor drive 6 is arranged in a motor housing 15 together with the transmission 9 shown in FIG. 1. The motor housing 15 and the valve housing 11 each have a flange 16, 17, between which an insulator 18 is arranged. The insulator 18 is manufactured from plastic and has three ring elements 19 connected to one another. Furthermore, the motor housing 15 and the valve housing 11 are connected via a transverse support 20 that is at a distance from the flanges 16, 17. The transverse support 20 has an insulator 21 with a ring element 22 and has a screw 23 preferably manufactured from plastic.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A valve configured to control exhaust gas or fresh air in a drive unit of a motor vehicle or generator, comprising:
a valve housing having a duct;
an adjustable valve body configured to open or close a flow cross section of the duct; and
an electric-motor drive configured to adjust the adjustable valve body,
wherein the duct is thermally decoupled from the electric-motor drive.

11. The valve as claimed in claim 10, wherein the electric-motor drive forms a structural unit together with a transmission.

12. The valve as claimed in claim 10, further comprising:
a motor housing in which the electric-motor drive is arranged; and
an insulator arranged between the motor housing and the valve housing.

13. The valve as claimed in claim 12, wherein the motor housing and the valve housing each have mutually opposite flanges and the insulator is configured to space the flanges apart from one another.

14. The valve as claimed in claim 12, wherein the insulator is manufactured from plastic.

15. The valve as claimed in claim 12, wherein the insulator has at least one ring element configured to space the duct apart from the electric-motor drive.

16. The valve as claimed in claim 15, wherein a wall thickness of the at least one ring element is smaller than a height of the at least one ring element.

17. The valve as claimed in claim 13, wherein the motor housing and the valve housing are connected to one another via a transverse support arranged at a distance from the flanges and the transverse support has an insulator.

18. The valve as claimed in claim 12, wherein a drive shaft is fastened to the adjustable valve body and protrudes into the motor housing, the drive shaft is manufactured from a thermally poorly conductive material.

19. The valve as claimed in claim 18, wherein the drive shaft is plastic.
